(19) United States
(12) Patent Application Publication
(10) Pub. No.: US 2020/0311690 A1
(43) Pub. Date: Oct. 1, 2020

(54) SYSTEMS AND METHODS TO EXTEND MEETINGS INDICATED IN ELECTRONIC CALENDARS

(71) Applicant: Lenovo (Singapore) Pte. Ltd., Singapore (SG)

(72) Inventors: Axel Ramirez Flores, Cary, NC (US); Russell Speight VanBlon, Raleigh, NC (US); Rodrigo Felix de Almeida, Raleigh, NC (US); Ratan Ray, Cary, NC (US); Jonathan Co Lee, Cary, NC (US); James A. Hunt, Chapel Hill, NC (US)

(21) Appl. No.: 16/370,294

(22) Filed: Mar. 29, 2019

(51) Int. Cl. G06Q 10/10; G06Q 10/02; G06F 3/0481

(52) U.S. Cl. CPC G06Q 10/1095; G06F 3/0481; G06Q 10/02

(57) ABSTRACT

In one aspect, a device includes at least one processor and storage accessible to the at least one processor. The storage includes instructions executable by the at least one processor to determine that a meeting indicated in one or more electronic calendars is to be extended. The instructions are also executable to, based on the determination, extend the meeting at least in part by reserving an additional timeslot in the one or more electronic calendars and by associating information for the meeting with the reservation for the additional timeslot.

### FIELD

The present application relates to technically inventive, non-routine solutions that are necessarily rooted in computer technology and that produce concrete technical improvements.

### BACKGROUND

Sometimes a meeting between various participants can take longer than expected. However, as recognized herein, a room in which the participants are still meeting might already be electronically booked for other matters in a timeslot adjacent to the timeslot of the meeting itself, and it can be cumbersome and confusing to search both the electronic calendars for the participants and the electronic calendars for various rooms to find a common time and appropriate room for which to schedule a new meeting. There are currently no adequate solutions to the foregoing computer-related, technological problem.

### SUMMARY

Accordingly, in one aspect a device includes at least one processor and storage accessible to the at least one processor. The storage includes instructions executable by the at least one processor to determine that a meeting indicated in one or more electronic calendars is to be extended. The instructions are also executable to, based on the determination, extend the meeting at least in part by reserving an additional timeslot in the one or more electronic calendars and by associating information for the meeting with the reservation for the additional timeslot.

In some embodiments, the instructions may be executable to present a graphical user interface (GUI) on a display, where the GUI may indicate that the meeting can be extended, and to determine that the meeting is to be extended at least in part based on receipt of user input to the GUI. Additionally, or alternatively, the instructions may be executable to identify one or more people at a scheduled conclusion time for the meeting (or a threshold non-zero time before the conclusion time) based on input from at least one sensor, and to determine that the meeting is to be extended based at least in part on the identification of the one or more people.

The information for the meeting may be associated with the reservation for the additional timeslot at least in part by providing an email indicating both the additional timeslot and the information, and/or by indicating the information in an entry for the additional timeslot established in at least a first electronic calendar of the one or more electronic calendars. The first electronic calendar may be a personal electronic calendar of an attendee of the meeting or an electronic calendar for a room that indicates availability of the room.

Also, in some embodiments, the additional timeslot may be a first timeslot different from a second timeslot that establishes a start time for the meeting, and the information may be identified from an entry in a first electronic calendar of the one or more electronic calendars. Thus, the second timeslot may occur before the first timeslot and the information may be copied from the entry. The first and second timeslots may not contiguous in some examples, and/or they may also be associated with different locations.

The information itself may include information related to a meeting subject, a meeting title, a listing of one or more meeting attendees, a number of meeting attendees, and/or a name of a meeting organizer.

In another aspect, a method includes determining that a meeting indicated in one or more electronic calendars is to be extended and, based on the determining, extending the meeting at least in part by reserving additional time for the meeting in the one or more electronic calendars and by associating previously-received information with the reservation.

In still another aspect, a computer readable storage medium (CRSM) that is not a transitory signal includes instructions executable by at least one processor to, responsive to the end of a meeting, identify whether a same room in which the meeting occurred is unscheduled at the end of the meeting. The instructions are also executable to, responsive to identifying that the same room is unscheduled at the end of the meeting, extend the meeting in the same room at least in part by automatically reserving a first time period beginning at the end of the meeting for the same room in at least one electronic calendar. Still further, the instructions are executable to, responsive to identifying that the same room is not unscheduled at the end of the meeting, access an electronic data structure of room calendars to present at least one alternate room with available time. The instructions are also executable to, responsive to selection of a first alternate room of the at least one alternate room, reserve the first alternate room for at least a second time period.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of an example network of devices in accordance with present principles;

FIG. 3 shows an example hub device in accordance with present principles;

FIG. 4 is a flow chart of an example algorithm for extending a meeting in accordance with present principles;

FIGS. 5-7 show various graphical user interfaces (GUIs) that may be presented in accordance with performing meeting extensions in accordance with present principles; and

FIG. 8 is an example graphical user interface (GUI) for configuring settings of a device undertaking present principles.

### DETAILED DESCRIPTION

The present application deals with the decoupling of the dependencies of needing an empty time slot immediately after a meeting is scheduled to end if the meeting should be extended and needing the same exact room if the meeting should be extended. This may be accomplished through an intelligent electronic reservation system that may consider the contexts of time and resource availability (e.g., availability of attendees and rooms).

For example, an end user may get a prompt that a meeting taking place in a certain room is scheduled to end. If that room is open/available for another timeslot immediately following the meeting's timeslot, then the end user may be given the option to extend the meeting to the other timeslot using the same room. Upon the user selecting this option, the electronic reservation system may reserve the selected time slot in the room's electronic calendar automatically and even the electronic calendars of each attendee automatically.

However, if that room is not open immediately after the meeting ends, then the electronic reservation system may search all or a subset of the room calendars to find another timeslot for the meeting extension for the user to select. This may allow the user to choose other rooms that might be open immediately after the meeting ends or a later time/date. Furthermore, a system administrator may adjust settings for the electronic reservation system to limit potential rooms that are presented as meeting extension options to a certain floor, a certain building, and/or a certain campus.

Furthermore, when extending a meeting, the electronic reservation system may use the existing meeting subject, attendees email list, attendee's headcount, and other information from the meeting as provided for the initial timeslot. A system administrator may even be able to set an attendee count rule so that only meeting rooms with the same capacity as the number of meeting attendees may be presented for selection, and/or the system administrator may leave the room capacity to attendee count rule open to provide more options to the end user/meeting organizer.

Furthermore, the electronic reservation system may also add attendees to information associated with the meeting when those attendees join mid-meeting, whether they join in person or by calling in to the meeting remotely. These additional attendees may even be detected via electronic connection to the meeting (online or via call-in) or via a wireless identifier for a device associated with the person (if attended in person).

Furthermore, the electronic reservation system may provide various meeting extension options depending on the amount of time free until a next meeting is scheduled to occur, providing a maximum time allowable for the user to extend the meeting for a given room. This could start with options in 15-minute increments, and/or the full amount of time until the start time of the next meeting may be indicated (or soonest half-hour or 1-hour boundary).

With respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino Calif., Google Inc. of Mountain View, Calif., or Microsoft Corp. of Redmond, Wash. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any general-purpose single- or multi-chip processor that can execute logic by means of various lines such as address lines, data lines, and control lines and registers and shift registers. Moreover, any logical blocks, modules, and circuits described herein can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library.

Logic when implemented in software, can be written in an appropriate language such as but not limited to C # or C++, and can be stored on or transmitted through a computer-readable storage medium (that is not a transitory, propagating signal per se) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI and includes programmable logic components programmed to perform the functions of an embodiment as well as general-purpose or special-purpose processors programmed with instructions to perform those functions.

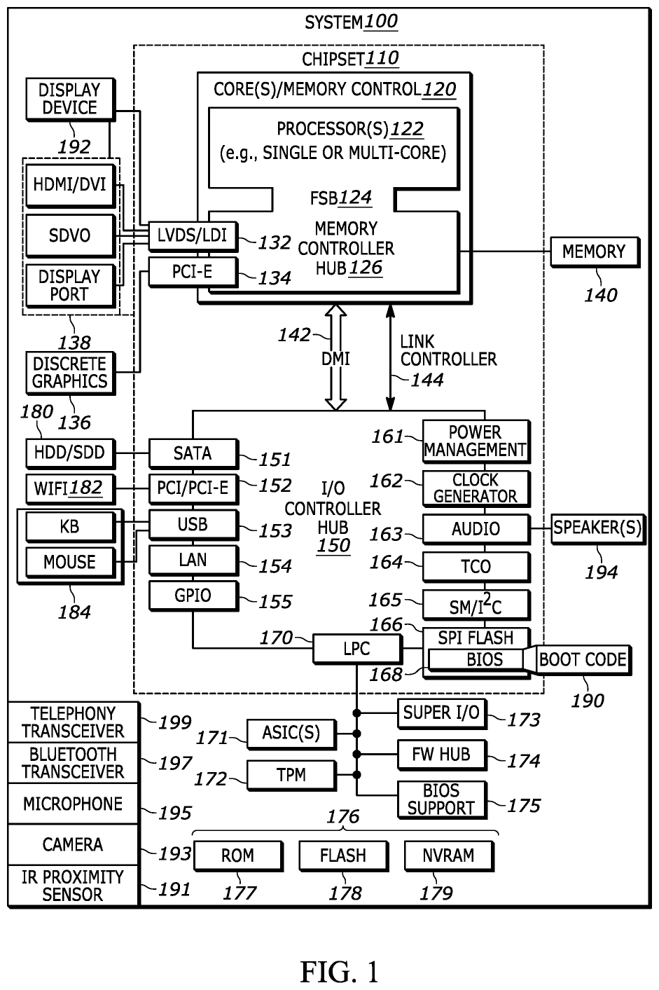

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case, the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super 1/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, the system 100 may include one or more sensors accessible to the one or more processors 122 so that input from the one or more sensors may be provided to the one or more processors 122. For example, the system 100 may include one or more infrared (IR) proximity sensors 191, one or more cameras 193, one or more microphones 195, and/or one or more Bluetooth communication transceivers 197. The cameras 193 may be, for example, thermal imaging cameras, infrared (IR) cameras, digital cameras such as webcams, three-dimensional (3D) cameras, and/or cameras otherwise integrated into the system 100 and controllable by the processor 122 to gather pictures/images and/or video. The one or more Bluetooth communication transceivers 197 may be classic Bluetooth transceivers and/or Bluetooth low energy (BLE) transceivers (e.g., Bluetooth 4.0 transceivers) for communicating with other devices using Bluetooth communication protocols.

Still further, a wireless telephony transceiver 199 may also be included in the system 100 as another example of a sensor in accordance with present principles. The telephony transceiver 199 may be a wired or wireless telephony transceiver, such as a wireless cellular telephone transceiver for wireless cellular communication over a cellular telephone network as well as other telephone networks.

Additionally, though not shown for simplicity, in some embodiments the system 100 may include other sensors such as a gyroscope that senses and/or measures the orientation of the system 100 and provides input related thereto to the processor 122, as well as an accelerometer that senses acceleration and/or movement of the system 100 and provides input related thereto to the processor 122. Also, the system 100 may include a GPS transceiver (another example of a sensor in accordance with present principles) that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

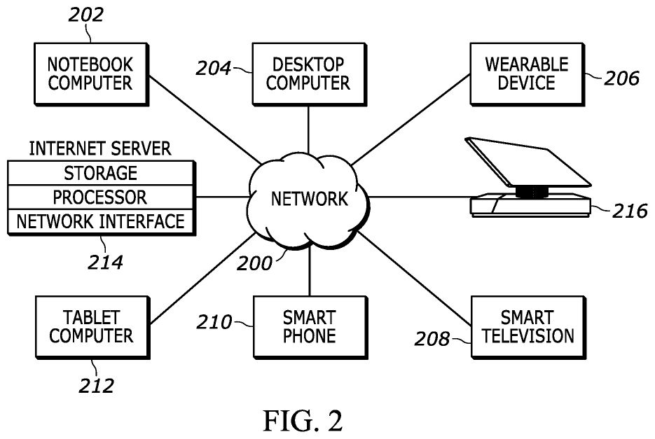

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, a conferencing hub device 216, and a server 214. The server 214 may be, for example, as an Internet server that may provide cloud storage accessible to the devices 202-212, 216 and that may also execute and manage an electronic reservation system/software in accordance with present principles. It is to be understood that the devices 202-216 are configured to communicate with each other over the network 200 to undertake present principles. Moreover, some or all of the devices 202-216 may be, for example, located within a same conference room as each other.

Describing the conferencing hub device 216 in more detail, it may be, for example an IP conference phone, a Lenovo ThinkSmart Hub 500, and/or a Lenovo ThinkSmart Hub 700 that communicates with the server 214 that operates some or all of the electronic reservation system/software (though in other embodiments the hub device 216 itself may operate the system/software). Furthermore, the conferencing hub device 216 may include, for example, one or more processors, one or more of the sensors such as the ones referenced herein, one or more touch-enabled displays, one or more storage areas, a keypad for telephone dialing, a speaker for providing audio, etc.

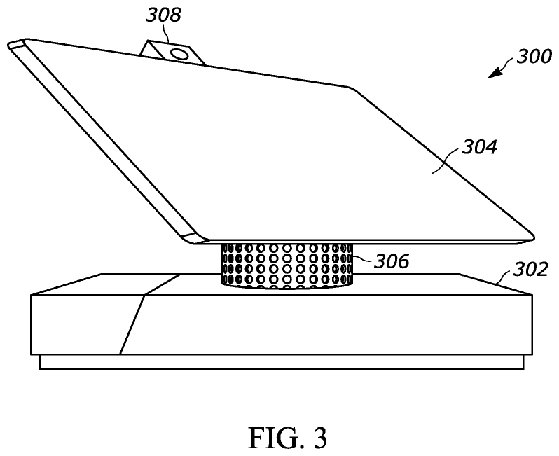

Now in reference to FIG. 3, it shows another example hub device 300 that may be similar to the hub device 216 described above. The hub device 300 may include a hub base 302 in which one or more system components may be housed, such as one or more processors, RAM, one or more storage areas, a microphone for detecting sound, etc. The base 302 may be connected to a touch-sensitive display 304 via cylinder 306, with the cylinder 306 itself including, e.g., a speaker for providing audio. Coupled to the display 304 may be one or more sensors 308 such as one or more infrared (IR) proximity sensors and/or one or more cameras, though the sensors 308 may be located elsewhere on the device 300 as well.

The display 304 itself may be rotatably coupled to the cylinder 306 for rotation in three dimensions so that, for example, it may be oriented at an oblique angle relative to the base 302 and any surface on which the base 302 may be placed as shown in FIG. 3. Additional orientations in which the display 304 may be rotated with respect to the base 302 include the display 304 being rotated such that its front surface is perpendicular to the top surface of the base 302 and the display 304 being rotated such that its front surface establishes a plane parallel to the top surface of the base 302.

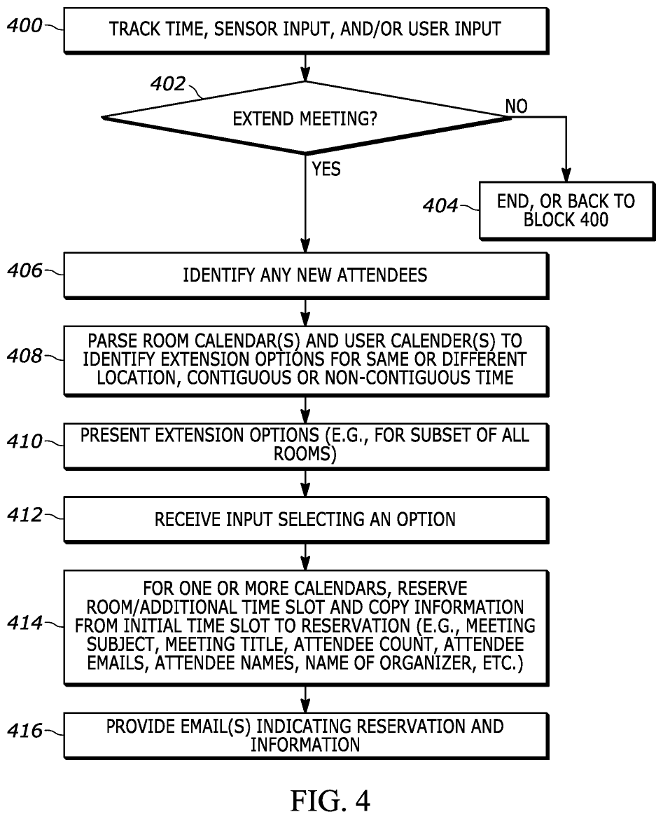

Referring to FIG. 4, it shows example logic that may be executed individually or jointly by a device such as a conferencing hub device like the devices 216, 300 and/or a server like the server 214 to extend a meeting in accordance with present principles. Beginning at block 400 and during a meeting scheduled for an initial time slot, the device may track time as well as any sensor input and user input that the device receives. For example, the device may use a clock or timer application to track time to determine when the time arrives that the meeting is scheduled to conclude.

Also, at block 400, the device may receive input from one or more sensors disposed within a room in which the meeting is occurring (e.g., on the hub device itself) for that input to be used to subsequently determine whether to extend the meeting. For example, IR proximity sensor software may be executed to determine based on IR proximity sensor input whether one or more people are still located within the room. Additionally, or alternatively, facial or object recognition software may be executed to determine based on images from a camera whether one or more people are still located within the room, how many people are still located within the room, and the identity of those people.

Other sensor input that also indicates attendee presence within the room may also be used. E.g., use of a telephony transceiver on the hub device (disposed within the room) may indicate attendee presence, a paired Bluetooth connection between the hub device and at least one attendee personal device may indicate attendee presence, recognition of spoken words detected by a microphone on the hub device may indicate attendee presence, user input received at a touch-enabled display of the hub device may indicate attendee presence, input from a gyroscope and/or accelerometer on the hub device or another device within the room may indicate motion and hence attendee presence caused by the motion, and recognition of GPS coordinates from an attendee's personal device as indicating the personal device as being within the room may indicate attendee presence, etc.

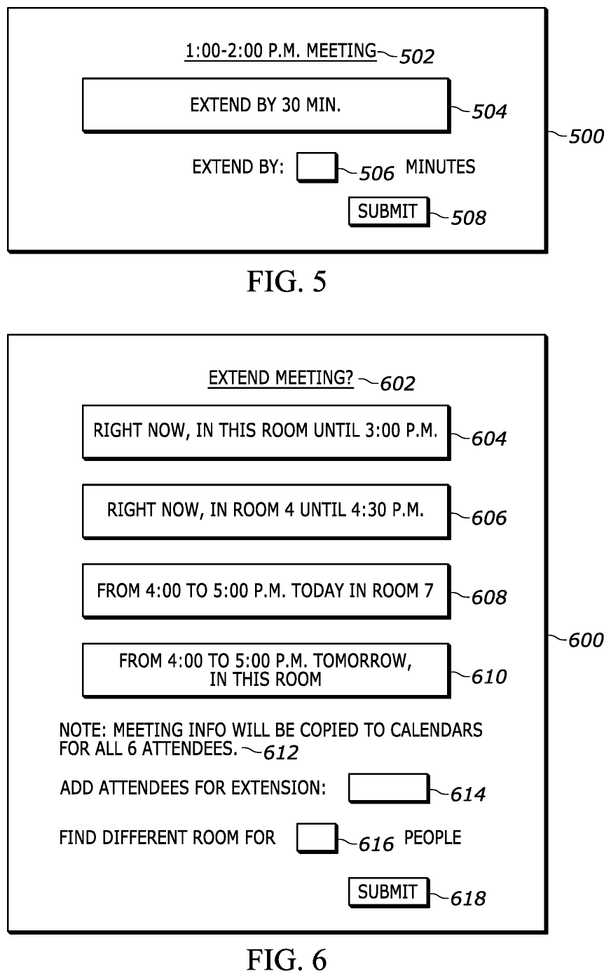

As far as user input that might be received at block 400, the user input may be, for example, voice input to a microphone that indicates that the meeting should be extended or touch input to a touch-enabled display that indicates that the meeting should be extended. For example, voice recognition software may be executed on signals received from a microphone to determine that an attendee (e.g., the meeting organizer) has provided a command via the microphone to “extend the meeting by half an hour”. As another example, an attendee may have selected a selector presented on the display of the conferencing hub device disposed within the room to indicate that the meeting should be extended by a preset or user-defined amount of time. An example of such a selector will be described below in reference to FIG. 5.

The logic of FIG. 4 may then move from block 400 to decision diamond 402. At diamond 402 the device may determine whether to extend the meeting based on the tracking performed at block 400. For example, at a scheduled conclusion time for the meeting or at a threshold non-zero time before the scheduled conclusion time (e.g., two minutes before) as determined by tracking time at block 400, the device may determine that one or more people are still present within the room based on sensor input or user input as set forth above. Additionally, or alternatively, the determination in the preceding sentence may also be performed at a threshold non-zero time after the scheduled conclusion time, such as five minutes after.

Responsive to a negative determination at diamond 402, the logic may proceed to block 404 where the logic may end, or the logic may revert back to block 400 and proceed therefrom. Responsive to an affirmative determination at diamond 402, the logic may instead proceed to block 406. At block 406 the device may then identify any new attendees that might have joined the meeting in person (or via telephone call-in or via an online portal) but that were not noted by the meeting's organizing person as an attendee in the electronic reservation itself as might have been created in an electronic calendar for the room and/or one or more personal electronic calendars of the other attendees.

The new attendees may be identified at block 406 by, for example, analyzing IR proximity sensor input using IR proximity sensor software to determine that more people are currently present in the room than the number of attendees listed in the electronic reservation. As another example, the new attendees may be identified at block 406 by analyzing images from a camera using facial or object recognition software to determine that more people are currently present in the room than the number of attendees listed in the electronic reservation system. In some examples, at block 406 the electronic calendars corresponding to recognized new attendees may also be identified, e.g., by accessing a relational database that indicates respective electronic calendars for respective people.

From block 406 the logic may then proceed to block 408 where the device may parse one or more electronic calendars for the rooms that are user-agnostic and also parse one or more personal electronic calendars associated with the respective attendees themselves (including calendars for the attendees identified at block 406). The device may do so at block 408 to compare time slots from the room and personal electronic calendars to identify a common timeslot that each of the calendars indicates as currently available. For example, the device may identify contiguous or non-contiguous time slots to the initial time slot that all attendees are available per their respective electronic calendars, while also identifying a room that is available during those contiguous or non-contiguous time slots. The room may be the same room as the attendees are currently located or a different room, depending on availability in respective electronic calendars for the respective rooms.

After block 408 the logic may proceed to block 410. At block 410 the device may present meeting extension options to one or more of the attendees, e.g., by presenting them via a conferencing hub device within the room or by presenting them via the personal device of the meeting organizer. The options may be presented audibly over one or more speakers or visually via a display. An example visual presentation will be described below in reference to FIG. 6.

It is to be further understood that in some embodiments, options may be presented at block 410 for only a subset of all available rooms, as might have been configured by a system administrator or the meeting organizer himself/herself. For example, a preference may be indicated that only options for available rooms on a same building floor as the current meeting should be presented, that only options for available rooms in a same building as the current meeting should be presented, and/or that only options for available rooms at a same campus (e.g., geographic location) should be presented.

From block 410 the logic may then proceed to block 412. At block 412 the device may receive user input selecting one of the presented options. The user input received at block 412 may thus be audible input received via a microphone, and/or touch input received via a touch-enabled display on which the options are presented visually. Then, responsive to the input received at block 412, the logic may move to block 414 where the device may reserve the selected timeslot for the meeting extension in both the electronic room calendar for the room associated with the selected option and each electronic personal calendar of each attendee. Also, at block 414, the device may copy information from the initial meeting entry in one or more of the calendars, as might have been provided by the organizer when initially organizing the meeting. For example, the meeting's title, subject, attendee count (number of attendees), attendee email addresses, attendee names, and the name of the meeting organizer/leader may all be copied to the entry for the selected timeslot in one or more of the rooms/personal electronic calendars.

From block 414 the logic may then move to block 416. At block 416 the device may transmit respective emails to the respective attendees at the email addresses that were copied. The emails may indicate the meeting extension reservation as well as one or more pieces of the information that were copied to the extension reservation.

Continuing the detailed description in reference to FIG. 5, it shows an example graphical user interface (GUI) 500 in accordance with present principles that may be presented on a display of a conferencing hub device, a meeting organizer's personal device, etc. The GUI 500 may be presented for the duration of an initial timeslot during which a meeting has been scheduled, or responsive to one or more of the determinations described above in reference to decision diamond 402.

As shown in FIG. 5, the GUI 500 may include a text indication 502 of the initial timeslot as well as a selector 504 that is selectable (e.g., via touch input) to provide user input to extend the meeting by a preset time of thirty minutes. The GUI 500 may also include an input box 506 at which a user may specify another time by which to extend the meeting, which may then be submitted to the system based on selection of the submit selector 508.

FIG. 6 shows another example GUI 600. The GUI 600 may be presented responsive to identification of one or more extension options as set forth herein. For example, the GUI 600 may be presented as described at block 410 above on the display of a conferencing hub device or meeting organizer's personal device.

As shown in FIG. 6, the GUI 600 may include a text prompt 602 asking whether a meeting should be extended. The GUI 600 may also include one or more selectors 604-610 depending on common room and attendee timeslots that have been identified as available in accordance with present principles. For example, selector 604 may be selected to provide a command to extend the meeting to a contiguous timeslot in the same room as was initially used for the meeting until a time at which the room will become unavailable due to another meeting that has also been scheduled for the same room (e.g., 3:00 p.m.). The selector 606 may be selected to provide a command to extend the meeting to a contiguous timeslot in a different room than was initially used for the meeting until a time at which the different room will become unavailable due to another meeting that has also been scheduled for the different room (e.g., 4:30 p.m.)

Additionally, the selector 608 may be selected to provide a command to extend the meeting to a non-contiguous timeslot (e.g., end time of initial timeslot separated by an hour from start time of meeting extension timeslot) in a different room than was initially used for the meeting during an available timeslot for the different room (e.g., from 4:00 p.m. to 5:00 p.m. on the same day/date that the meeting began). The selector 610 may be selectable to provide a command to extend the meeting to a non-contiguous timeslot on a different day/date than the initial timeslot but in a same room as was used for the first part of the meeting.

In some embodiments, the GUI 600 may further include a note 612 informing a viewer of the GUI 600 that information for the meeting as associated with the initial timeslot will be copied to entries for the meeting extension in the personal calendars of all meeting attendees. Even further, in some embodiments a user may be permitted to add additional attendees to be invited to and/or included in the meeting extension via input box 614, or to indicate a different number of attendees for the meeting extension via input box 616 so that the system may locate rooms that can accommodate that different number of attendees. A submit selector 618 may then be selected to submit, to the system, one or both of the additional attendees entered into box 614 or the number entered into box 616.

Continuing the detailed description in reference to FIG. 7, it shows an example GUI 700 that may be presented on the display of a conferencing hub device, a meeting organizer's personal device, and/or the device of each attendee of an extended meeting. In some embodiments, the GUI 700 may even form part of an email sent to the respective email address associated with each attendee. Such an email may be sent, for example, at block 416 as described above.

As shown in FIG. 7, the GUI 700 may include a text indication 702 that the meeting has been extended, as well as a text indication 704 of a timeslot and room at which the extended meeting will continue. The GUI 700 may also include one or more pieces of information 706 that were copied from an electronic calendar entry for the initial meeting timeslot, such as a title 708 for the meeting given by the meeting's organizer as well as a listing 710 of the names of the meeting's attendees.

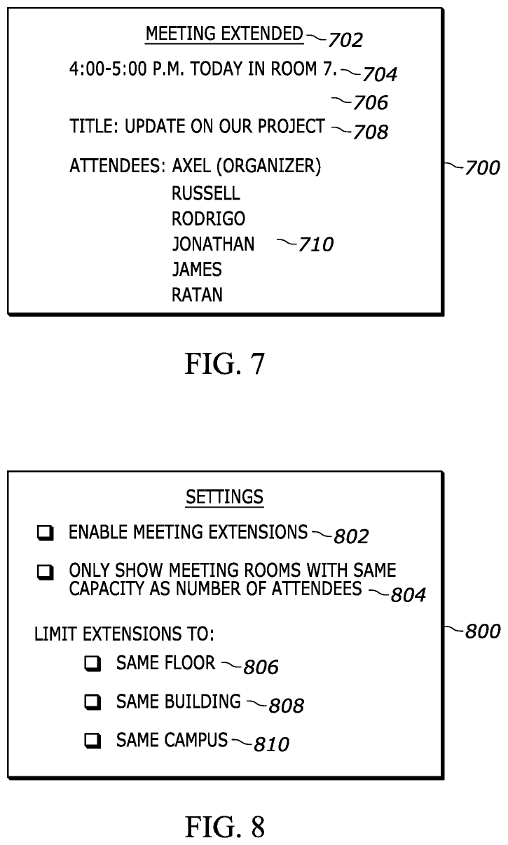

Now describing FIG. 8, it shows an example GUI 800 that may be presented via the personal device of a system administrator, meeting organizer, or another person (or via another device) to configure one or more settings of a device or electronic reservation system undertaking present principles. Each option to be discussed below may be selected via selection of the respective check box shown adjacent to the respective option.

As shown, the GUI 800 may include a first option 802 that may be selectable to enable the system to determine that a meeting is to be extended and to identify potential timeslots and rooms for the meeting extension. For example, the option 802 may be selected to configure the system to undertake the logic of FIG. 4 and the other actions described herein.

The GUI 800 may also include a second option 802 for the system to only present meeting extensions in relation to rooms that have a capacity corresponding to the number of attendees of the meeting extension. The capacity itself for each room may have been entered into the system by a person such as a system administrator, and/or may be indicated in a data structure of electronic room calendars.

Still further, the GUI 800 may include options 806-810 for the system administrator, meeting organizer, and/or another person to limit rooms for which availability for a meeting extension will be searched so that the search is limited to a subset of all available rooms. Thus, selector 806 may be selected to limit the meeting extension to only rooms on a same floor as the room for the initial timeslot. Selector 808 may be selected to limit the meeting extension to only rooms in a same building as the room for the initial timeslot. Selector 810 may be selected to limit the meeting extension to only rooms on a same campus as the room for the initial timeslot and not, e.g., a different campus in a different state or country.

Moving on from FIG. 8, it is to be understood that present principles apply to more than meeting extensions for just rooms. For example, the electronic reservation system may extend meetings to other locations such as building lobbies, outside areas, etc.

It may now be appreciated that present principles provide for an improved computer-based user interface(s) that improves the functionality and ease of use of electronic reservation systems and/or electronic calendars. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A device, comprising:
at least one processor; and
storage accessible to the at least one processor and comprising instructions executable by the at least one processor to:
determine that a meeting indicated in one or more electronic calendars is to be extended; and
based on the determination, extend the meeting at least in part by reserving an additional timeslot in the one or more electronic calendars and by associating information for the meeting with the reservation for the additional timeslot.

2. The device of claim 1, wherein the instructions are executable by the at least one processor to:
determine that the meeting is to be extended at least in part based on receipt of user input to a graphical user interface (GUI).

3. The device of claim 2, wherein the instructions are executable by the at least one processor to:
present the GUI on a display, the GUI indicating that the meeting can be extended.

4. The device of claim 1, wherein the instructions are executable by the at least one processor to:
identify, at a scheduled conclusion time for the meeting and based on input from at least one sensor, one or more people at a location at which the meeting transpires, and
determine that the meeting is to be extended based at least in part on the identification of the one or more people.

5. The device of claim 1, wherein the instructions are executable by the at least one processor to:
identify, at a threshold non-zero time before a scheduled conclusion time for the meeting and based on input from at least one sensor, one or more people at a location at which the meeting transpires; and
determine that the meeting is to be extended based at least in part on the identification of the one or more people.

6. The device of claim 1, wherein the information for the meeting is associated with the reservation for the additional timeslot at least in part by providing an email indicating both the additional timeslot and the information.

7. The device of claim 1, wherein the information for the meeting is associated with the reservation for the additional timeslot at least in part by indicating the information in an entry for the additional timeslot, the entry established in at least a first electronic calendar of the one or more electronic calendars.

8. The device of claim 7, wherein the first electronic calendar is selected from the group consisting of: a personal electronic calendar of an attendee of the meeting, an electronic calendar for a room that indicates availability of the room.

9. The device of claim 1, wherein the additional timeslot is a first timeslot different from a second timeslot that establishes a start time for the meeting, and wherein the information is identified from an entry in a first electronic calendar of the one or more electronic calendars, the entry being for the second timeslot, the second timeslot occurring before the first timeslot.

10. The device of claim 9, wherein the information is copied from the entry.

11. The device of claim 1, wherein the additional timeslot is a first timeslot different from a second timeslot that establishes a start time for the meeting, and wherein the first and second timeslots are not contiguous.

12. The device of claim 11, wherein the first and second timeslots are associated with different locations.

13. The device of claim 1, wherein the information comprises information related to one or more of: a meeting subject, a meeting title, a listing of one or more meeting attendees, a number of meeting attendees, a name of a meeting organizer.

14. A method, comprising:
determining that a meeting indicated in one or more electronic calendars is to be extended; and
based on the determining, extending the meeting at least in part by reserving additional time for the meeting in the one or more electronic calendars and by associating previously-received information with the reservation.

15. The method of claim 14, comprising:
extending the meeting by reserving additional time for the meeting that is non-contiguous with an initial timeslot for the meeting.

16. The method of claim 14, comprising:
extending the meeting by reserving additional time for the meeting at a different location than an initial location for the meeting.

17. The method of claim 14, comprising:
extending the meeting by reserving contiguous additional time for the meeting at a same location as an initial location for the meeting.

18. A computer readable storage medium (CRSM) that is not a transitory signal, the computer readable storage medium comprising instructions executable by at least one processor to:
responsive to the end of a meeting, identify whether a same room in which the meeting occurred is unscheduled at the end of the meeting;
responsive to identifying that the same room is unscheduled at the end of the meeting, extend the meeting in the same room at least in part by automatically reserving a first time period beginning at the end of the meeting for the same room in at least one electronic calendar;
responsive to identifying that the same room is not unscheduled at the end of the meeting, access an electronic data structure of room calendars to present at least one alternate room with available time; and
responsive to selection of a first alternate room of the at least one alternate room, reserve the first alternate room for at least a second time period.

19. The CRSM of claim 18 wherein the first alternate room is reserved at least in part using one or more of: meeting subject, attendees' emails, and attendees count.

20. The CRSM of claim 18, wherein accessing the electronic data structure of room calendars is limited to a subset of rooms in the electronic data structure, and wherein the subset is limited to one or more of: rooms on a single floor, rooms in a single building, rooms on a single campus, rooms with a capacity defined by a number of invitees.
